(19) United States
(12) Patent Application Publication
(10) Pub. No.: US 2009/0200391 A1
(43) Pub. Date: Aug. 13, 2009

(54) Residential Irrigation and Fertilization system

(76) Inventors: Gali Yehuda, Tel-Aviv (IL); Yehuda Einav, Kfar Truman (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/030,297

(22) Filed: Feb. 13, 2008

(51) Int. Cl. A01C 23/00; A01C 23/04; B05B 7/30; B05B 7/24; B01F 5/00; B05D 1/02

(52) U.S. Cl. 239/10; 239/226; 239/317; 137/896; 137/1

(57) ABSTRACT

An irrigation device for introducing chemical into irrigation water, the irrigation device whereby a first stream of water flows from an input pipe connector, through a first container, through the gear-driven motor mounted in the first container, through a first pipe into a second container while the gear-driven motor rotates the second container; and a second stream of water flowing from the first container, through a second pipe into a third container containing the chemical, and through the a third pipe into the second container while the second container is moving.

### FIELD AND BACKGROUND OF THE INVENTION

The present invention relates to irrigation systems and, more particularly, but not exclusively to a square-area a residential fertigation applicator.

Currently, there exist a number of systems for applying chemicals such as fertilizers and pesticides to a residential lawn or the like. Some systems disperse the fertilizers within irrigation water. The combination of irrigation and fertilization is named fertigation.

In a common procedure of using a fertigation system, solid or liquid fertilizer is first placed in a container. Then the container is filled with irrigation water, usually from a garden faucet. Then the water with the dissolved fertilizer is sprayed on the lawn by use of a sprinkler assembly, which is connected either directly to the container, or via a garden hose.

Agricultural fertigation systems use a dissolving container at the head of an irrigation line and divided from the sprinklers along the irrigation lines. Some fertigation systems use a suction device based on the Venturi effect to suck liquid fertilizer into the irrigation line. The following U.S. patent applications Ser. No. are believed to represent the most relevant prior art: U.S. Pat. Nos. 6,161,779, 5,918,621, 4,941,616, 4,852,802, 4,635,848, 4,333,493, 4,171,710 and 3,556,141.

However, such configuration is disadvantageous for residential fertigation systems, where a single unit combining the dissolving container and the sprinkler is required. There is thus a widely recognized need for, and it would be highly advantageous to have, a residential fertigation system devoid of the above limitations.

### SUMMARY OF THE INVENTION

According to one aspect of the present invention there is provided an irrigation device operative to introduce chemical into irrigation water flow. The irrigation device includes the following parts:
a first container housing a gear-driven motor and having an input pipe connector operative to be connected to pressurized water supply;
a second container connected by a first pipe to the first container, the second container including at least one nozzle operative for spraying irrigation water, the second container being movable by the gear-driven motor; and
a third container operative to dissolve said chemical in water, the third container connected by a second pipe to the first container ahead of the gear-driven motor, and a third pipe connected to the second container;
whereby a first stream of water flows from the input pipe connector, through the first container, through the gear-driven motor, and through the first pipe into the second container while the second container is moving, and a second stream of water flowing from the first container, through the second pipe into the third container, and through the third pipe into the second container while the second container is moving.

According to another aspect of the present invention there is provided an irrigation device operative to introduce chemical into irrigation water flow wherein the first pipe includes a suction unit firmly connected to the second container, the suction unit including a tube connecting the first container and the second container, the tube including a hole; and a housing unit forming a closed cavity around the hole and firmly connected by the third pipe to the third container; and wherein the first pipe is operative to merge a first stream of water flowing from the third container, through the hole, into a second stream of water flowing from the first container to the second container through the tube.

According to yet another aspect of the present invention there is provided an irrigation device operative to introduce chemical into irrigation water flow wherein the suction unit including: a tube having a constriction and flaring from the constriction towards both ends of the tube; and a hole in a wall of the tube at the constriction.

According to still another aspect of the present invention there is provided an irrigation device operative to introduce chemical into irrigation water flow wherein the suction unit is a Venturi device.

Yet according to another aspect of the present invention there is provided an irrigation device operative to introduce chemical into irrigation water flow wherein the third container includes an opening enabling a user to input dissolvable material into the third container.

Still according to another aspect of the present invention there is provided an irrigation device operative to introduce chemical into irrigation water flow wherein the chemical includes solid, fertilizer liquid fertilizer, solid pesticide; and liquid pesticide.

Further according to another aspect of the present invention there is provided an irrigation device operative to introduce chemical into irrigation water flow wherein the third container includes a depression and wherein at least one of the second container, the first pipe, the suction device, the housing unit, and the third pipe is mounted in the depression.

Yet further according to another aspect of the present invention there is provided an irrigation device operative to introduce chemical into irrigation water flow wherein the third container includes at least one reinforcement binding connecting its walls.

Still further according to another aspect of the present invention there is provided an irrigation device operative to introduce chemical into irrigation water flow wherein the third container includes at least one water-flow diverting unit operative to circulate the water-flow through the third container.

According to another aspect of the present invention there is provided a rotating suction unit including:
a tube including:
   a constriction and flaring from the constriction towards both ends of the tube,
   a tube hole through a wall of the tube at the constriction; and
   a cylindrical outer surface at least partially around the hole and along the tube; and
a housing mounted around at least a part of the tube, the housing including:
   an internal recess including edges at least partially round and attached to the cylindrical outer surface of the tube to form a sealed cavity around the tube hole;
   a pipe external to the housing and connecting to the cavity through a hole in a wall of the housing;
wherein the tube and the housing are configured to enable:
   rotation of the housing at least partially around the tube; and
   rotation of the tube at least partially within the housing;
wherein the cavity is connected to the tube hole throughout the rotation, and wherein the edges are attached to the cylindrical outer surface of the tube throughout the rotation,
wherein a first end of the tube is operative to connect to a first source of liquid or gas to maintain a flow through the tube;
wherein the pipe is operative to connect to a second source of liquid or gas; and
wherein the flow thorough the tube creates suction at the tube hole to draw from the second source through the pipe and through the cavity and into the flow.

According to yet another aspect of the present invention there is provided a method for moving an irrigation nozzle while introducing chemical into irrigation water flow, the irrigation method including:
providing a gear-driven motor mounted in a first container, the first container and having an input pipe connector operative to be connected to pressurized water supply;
providing a second container connected by a first pipe to the first container, the second container including at least one nozzle operative for spraying irrigation water, the second container being movable by the gear-driven motor; and
providing a third container including an opening for inputting chemical, such as soluble material or liquid chemical, into the third container, the third container operative to dissolve the chemical in water, the third container connected by a second pipe to the first container ahead of the gear-driven motor, and a third pipe connected to the second container;
proving chemical into the third container; and
providing a first stream of water flowing from the input pipe connector, through the first container, through the gear-driven motor, and through the first pipe into the second container while the second container is moving, and a second stream of water flowing from the first container, through the second pipe into the third container, and through the third pipe into the second container while the second container is moving.

According to still another aspect of the present invention there is provided a method for introducing a first liquid into a flow of a second liquid, the method including:
providing a flow of the first liquid through a tube, the tube including:
   a constriction and flaring from the constriction towards both ends of the tube,
   a tube hole through a wall of the tube at the constriction; and
   a cylindrical outer surface at least partially around the hole and along the tube;
   wherein the flow thorough the tube creates suction at the tube hole;
providing a housing mounted around at least a part of the tube, the housing including:
   an internal recess including edges at least partially round and attached to the cylindrical outer surface of the tube to form a sealed cavity around the tube hole;
   a pipe external to the housing and connecting to the cavity through a hole in a wall of the housing;
   wherein the tube and the housing are configured to enable:
      rotation of the housing at least partially around the tube; and
      rotation of the tube at least partially within the housing; p2 wherein the cavity is connected to the tube hole throughout the rotation, and wherein the edges are attached to the cylindrical outer surface of the tube throughout the rotation, and
providing the second liquid at the pipe.

According to still another aspect of the present invention there is provided wherein the first liquid and the second liquid is gaseous.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases the order of process steps may varied without changing the purpose or effect of the methods described.

Implementation of the method and system of the present invention involves performing or completing certain selected tasks or steps manually, automatically, or any combination thereof. Moreover, according to actual instrumentation and equipment of preferred embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A, 1B and 1C are, respectively, a simplified illustration of a fertigation device, the fertigation device irrigating a lawn, and a top view of the fertigation device within a typical irrigating area;

FIGS. 2A and 2B are simplified yet more detailed illustrations of the fertigation device in perspective and side views, respectively;

FIG. 3A is a simplified perspective view of a suction device used in the fertigation device;

FIG. 3B is a simplified side view of the suction device;

FIG. 3C is a simplified side cut view of the suction device;

FIG. 3D is a simplified front cut view of the suction device;

FIGS. 4A and 4B are simplified schematics of a detail of FIG. 3B and FIG. 3C, respectively;

FIGS. 5A, 5B and 5C are simplified schematics of a perspective view, bottom view and cut side view, respectively, of a suction housing used with the suction device;

FIG. 6A is a simplified illustration of water with dissolved fertilizer flowing into a water chamber associated with the suction housing;

FIG. 6B is a simplified illustration of water with dissolved fertilizer flowing through the water chamber into the suction device;

FIG. 7 is a simplified illustration of the flow of irrigation liquid through the fertigation device;

FIGS. 8A, 8B, 8C, 8D and 8E are simplified schematics of, respectively, perspective view, top view, bottom view, latitude cut and longitude cut, of a dissolving container part of the irrigating device; and

FIG. 9 is a simplified illustration of a latitude cut of the dissolving container containing water.

### DESCRIPTION OF THE PREFERRED EMBODIMENTS

The present embodiments comprise a combination of irrigation and fertilization in residential use. The combination of irrigation and fertilization in a single action is hereby termed fertigation. The principles and operation of a fertigation device according to the present invention may be better understood with reference to the drawings and accompanying description. It is appreciated that the present invention is also applicable to other applications where chemicals, such as pesticides, are added to irrigation water. It is also appreciated that while in the description below chemicals are inserted into the irrigation system in the form of liquid or soluble powder, such chemicals can be also inserted in other forms, such as powder, concentrated liquid, etc., or combinations thereof.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

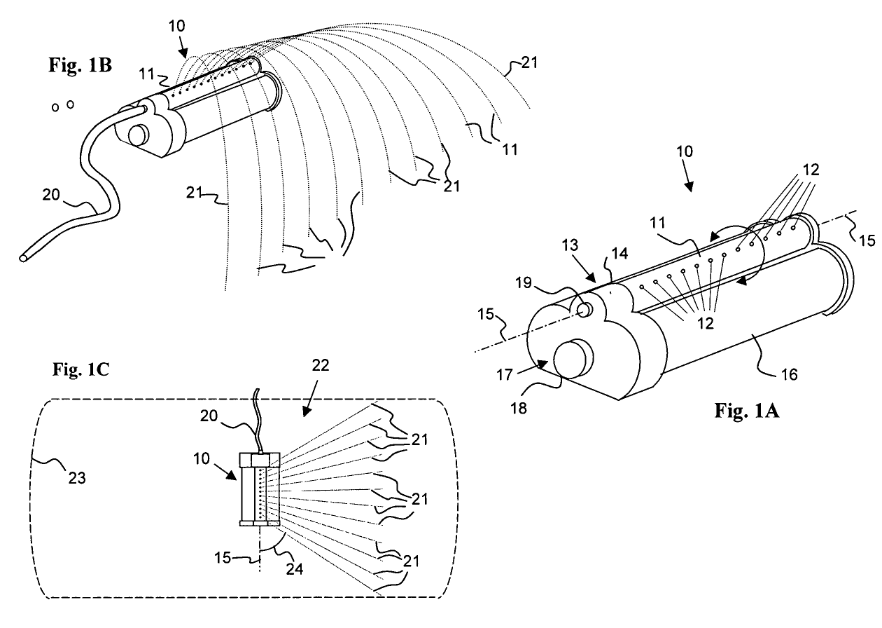

Reference is now made to FIGS. 1A, 1B and 1C, which are, respectively, a simplified illustration of a fertigation device 10 according to a preferred embodiment of the present invention, a simplified illustration of the fertigation device 10 irrigating a lawn, and a simplified top view illustration of the fertigation device 10 and a typical irrigating area.

As seen in FIG. 1A, the fertigation device 10 preferably includes the following main components:
a rotating nozzles tube 11 containing a plurality of water nozzles 12;
a gear-driven engine 13 (inside a front cover 14), operated by water pressure and operative to rotate the nozzles tube 11 from side to side around axis 15.;
a fertilizer dissolving container 16 with an opening 17 and a lid 18 for inserting fertilizer into the dissolving container 16;
a water hose connector 19 feeding water to the gear-driven engine 13 and into the dissolving container 16;
a suction device (not shown in FIG. 1A) sucking diluted fertilizer from the dissolving container 16 into the nozzles tube 11.

As seen in FIG. 1B, the fertigation device 10, preferably connects to hose 20, and preferably ejects via nozzles 12 a plurality of streams 21 of water carrying dissolved fertilizer. As the nozzles tube 11 rotates the streams 21 irrigate a predefined land area.

FIG. 1C shows the fertigation device 10 within an irrigated area 22 bounded by edges 23. As seen in FIG. 1C, the irrigated area is typically rectangular. The range of rotation of the nozzles tube 11 and the ejection angle 24 of nozzles 12 can be set. Therefore, the fertigation device 10 can be positioned at the center of the irrigated area, or off the center, with rotation limiters and the nozzles 12 adjusted to cover the required area.

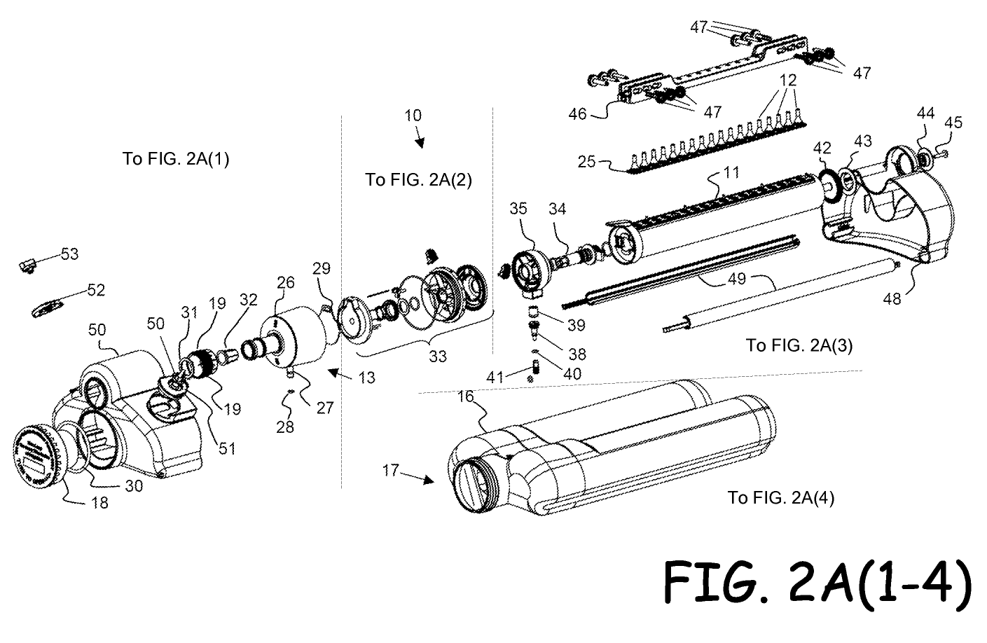

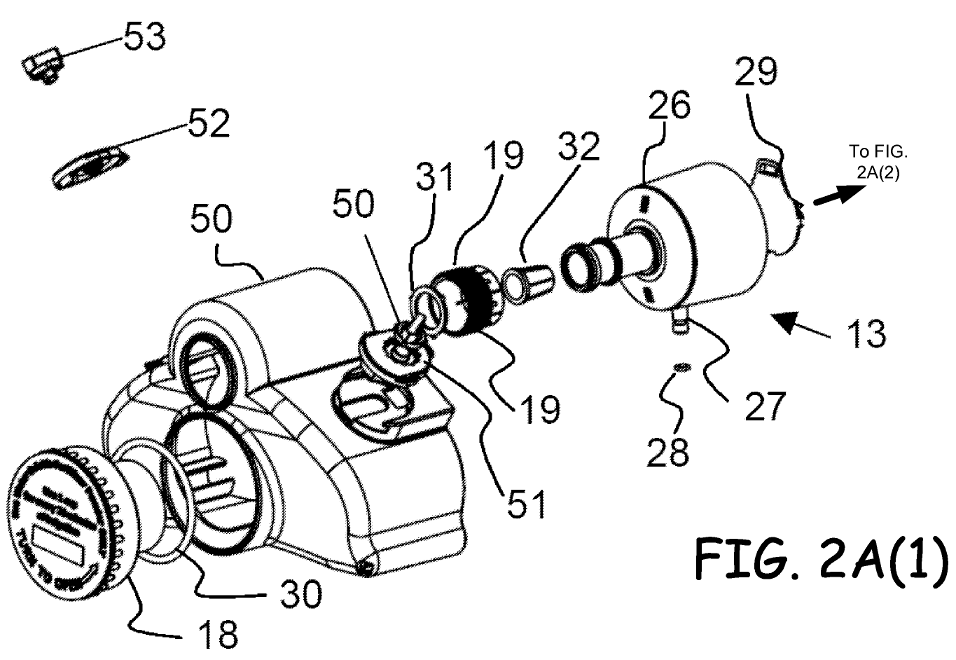

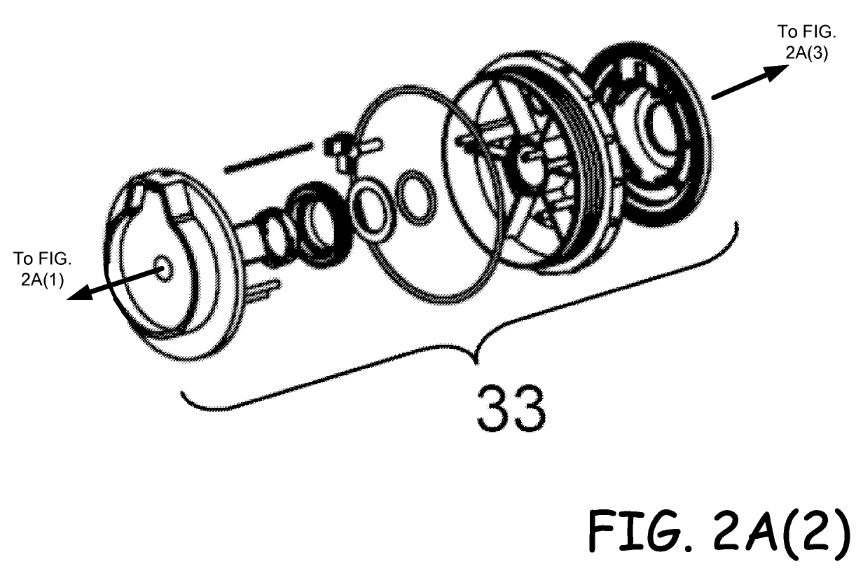

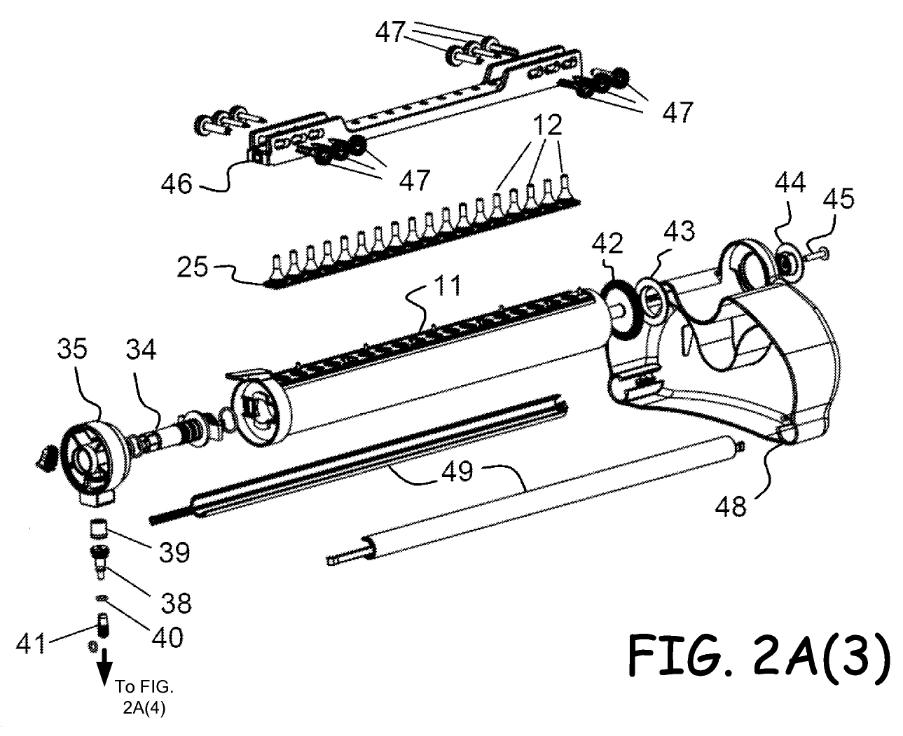

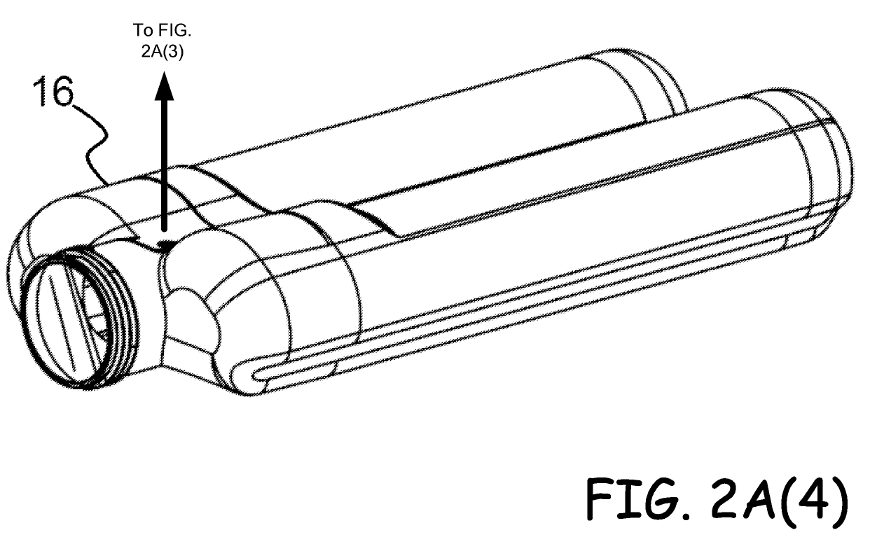

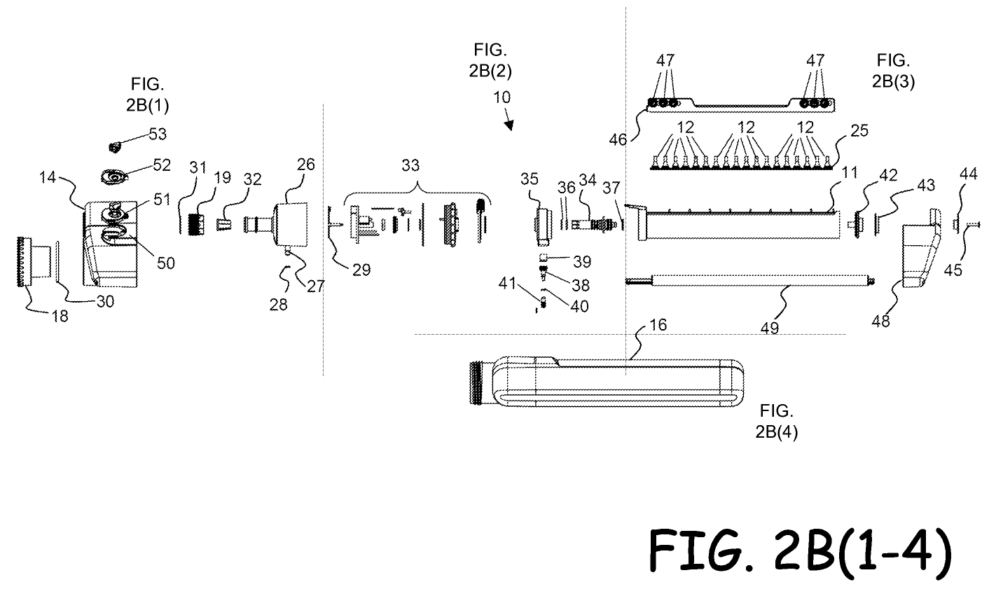

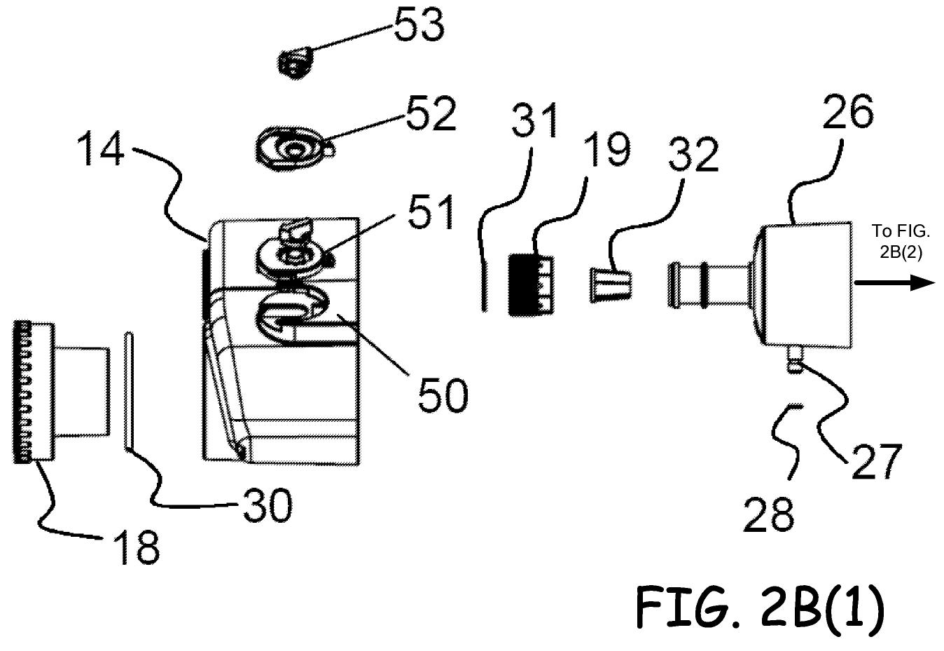

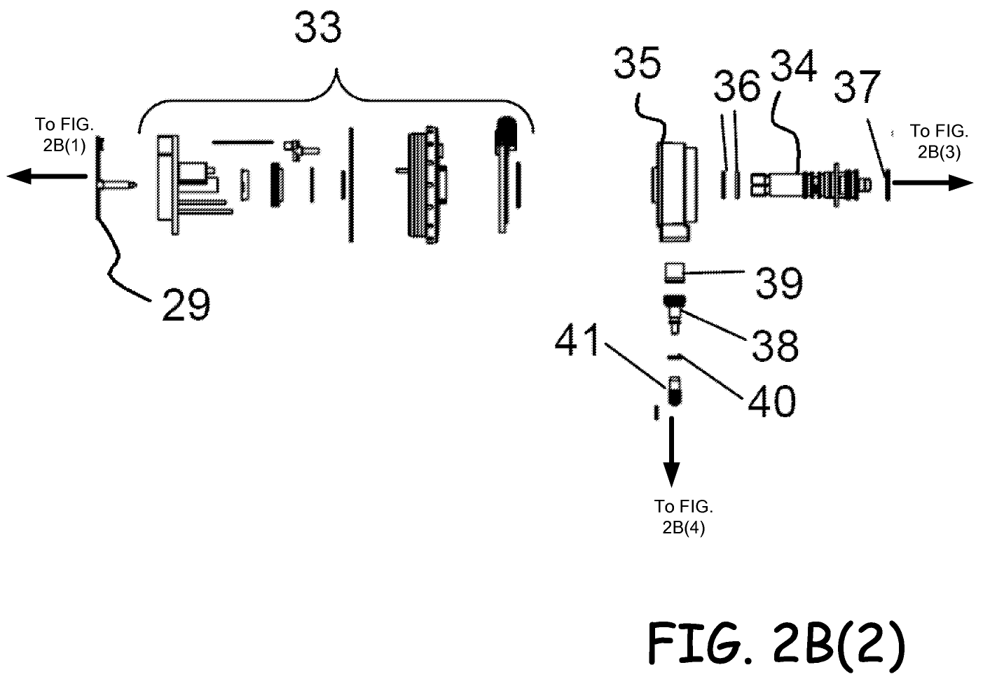

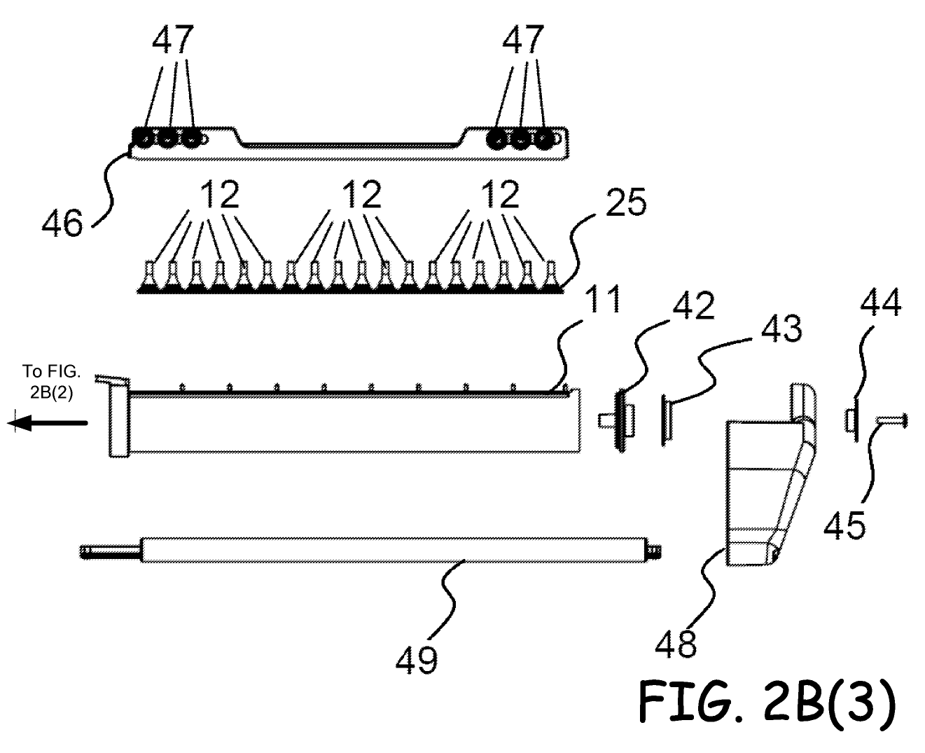

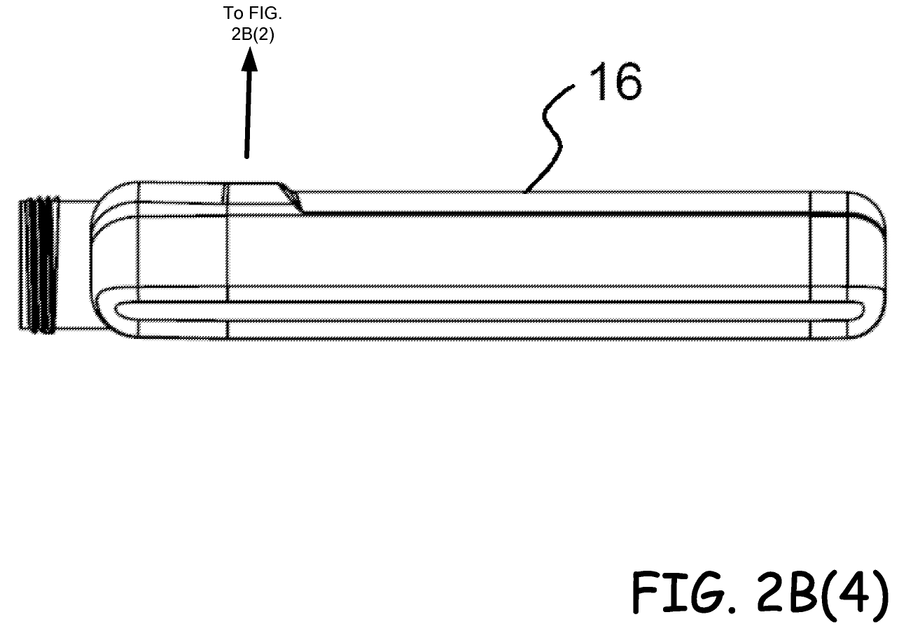

Reference is now made to FIGS. 2A and 2B, which are simplified and more detailed illustrations of the fertigation device 10, in perspective and side views, respectively, according to a preferred embodiment of the present invention.

As seen in FIGS. 2A and 2B, the fertigation device 10 preferably contains the following elements:
the nozzles tube 11;
a nozzles battery 25 containing nozzles 12;
a gear-driven engine box 26 containing water operated gear-driven engine 13, the gear-driven engine box 26 has a water outlet pipe 27 with an o-ring 28 that connect to the dissolving container 16, and a gear-driven engine box cover 29;
the front cover 14;
the dissolving container 16 with opening 17;
the lid 18 for opening 17 and an o-ring 30;
hose connector 19 with o-ring 31 and water filter 32;
a rotation limiter assembly 33;
a suction device 34 rotating within a suction housing 35, two o-rings 36 (shown in FIG. 2B) seal the connection between the suction device 34 and the suction housing 35 and a third o-ring 37 (also shown in FIG. 2B) seal the connection of the suction device 34 with the sprinklers container 11, the suction housing containing a inlet pipe 38, a one-way valve 39, an o-ring 40 and a filter 41, connecting the suction device to the dissolving container 16;
a nozzles tube cover 42, plug spacer 43, top cover 44 and screw 45;
a nozzle deflector 46 and nozzle rollers 47 for setting the sprinkling angles of the nozzles;
back cover 48;
two rods 49 connecting the front cover 14 to the back cover 48 and holding all intermediate parts in place; and
a day-of-month dial 50 and indicator 51 and an hour-of-day dial 52 and indicator 53 for indicating the last or the next irrigation time.

It is appreciated that the irrigated area 22 (shown in FIG. 1B) is determined by setting the rotation limiter assembly 33 to set the range of the rotation of the nozzles tube 11 and thus to set the length of the spraying, and by setting the nozzle rollers 47 to determine the deflection of the nozzles and thus to set the width of the spraying, Preferably, the nozzles battery 25 contains 18 nozzles, and the nozzle deflector 46 contains 6 nozzle rollers 47. Thus, the first, the second and third nozzles as well as the sixteenth, seventeenth, and eighteenth nozzles, can be closed to set the width of the irrigated area 22. Preferably, the nozzles 12 are made of an elastic material such as rubber, and each roller is movable within a slot to push on the nozzle and to bend it sideways so as to deflect the water stream.

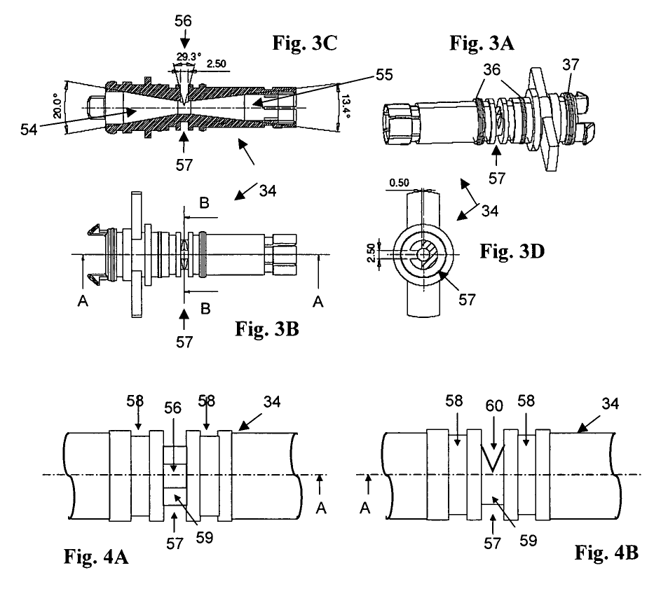

Reference is now made to FIGS. 3A, 3B, 3C and 3D, which are a simplified schematics of the suction device 34 according to a preferred embodiment of the present invention. FIG. 3A is a perspective view of the suction device 34, FIG. 3B is a side view, FIG. 3C is a side cut view, and FIG. 3D is a front cut view of the suction device 34.

As seen in FIG. 3C, the suction device 34 preferably uses the Venturi effect with an inlet cone 54 of 20 degrees, an outlet cone 55 of 13.4 degrees and a square suction hole 56 of 2.5 by 2.5 mm.

As seen in FIGS. 3A, 3B 3C, the suction device 34 preferably includes a recess 57 at the location of the suction hole 56, as marked in FIG. 3B by axis B. Preferably, the recess 57 surrounds the suction device 34 as seen in FIG. 3D.

Reference is now made to FIGS. 4A and 4B, which are a simplified schematics of a detail of FIG. 3B and FIG. 3C, respectively, according to a preferred embodiment of the present invention.

FIG. 4A shows o-ring grooves 58 at the two sides of suction hole 56. The body of the suction device 34 is preferably deeper engraved around at the suction hole 56 to create a water chamber 59.

FIG. 4B shows the suction device 34 at 90 degrees to FIG. 4A with respect to axis A. FIG. 4B shows a further recess, preferably a wedge shaped recess 60, into the body of the suction device 34, preferably at the recess 57, preferably further enlarging the water chamber 59 around the suction hole 56. As seen in FIG. 3C, the wedge shaped recess 60 has an angle of 29.3 degrees.

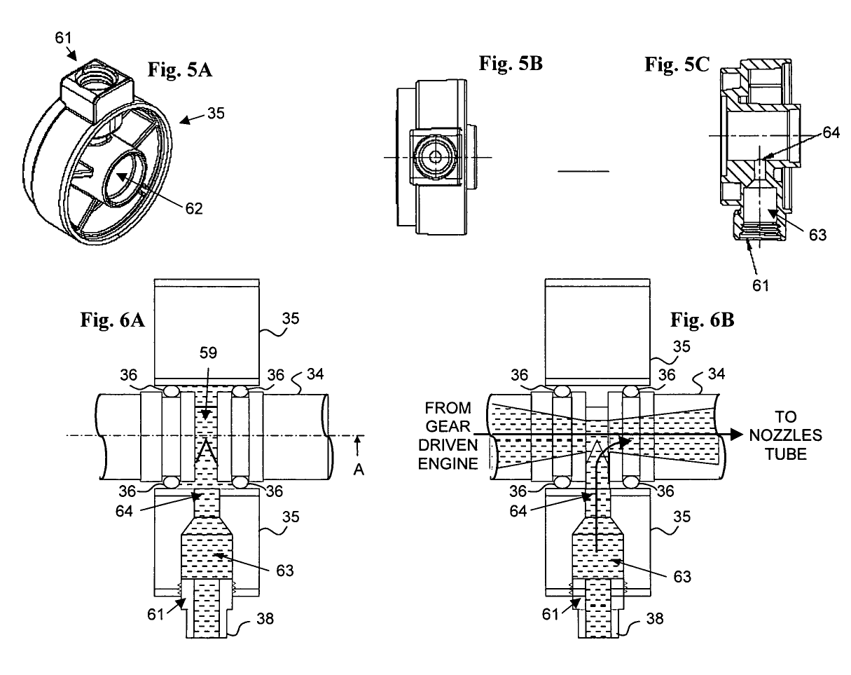

Reference is now made to FIGS. 5A, 5B and 5C, which are simplified schematics of the suction housing 35 in a perspective view, bottom view and cut side view, respectively, according to a preferred embodiment of the present invention.

FIG. 5A shows inlet opening 61 in the suction housing 35 where the inlet pipe 38 connects to the suction housing 35. FIG. 5A also shows cylinder 62 in the suction housing 35 where the suction device 34 is preferably inserted into the suction housing 35. FIG. 5C shows pipe 63 from inlet opening 61 to outlet 64 and into the water chamber 59 that is formed between the wall of the cylinder 62 and the wall of the recess 57 and the wedge shaped recess 60.

Reference is now made to FIGS. 6A and 6B, which are two simplified illustrations of water with dissolved fertilizer flowing into the water chamber 59 (FIG. 6A), and into the suction device 34 (FIG. 6B), according to a preferred embodiment of the present invention.

FIG. 6A shows water with dissolved fertilizer flowing from the dissolving container 16 (not shown in FIG. 6A) through inlet pipe 38 and through pipe 63 into the water chamber 59.

FIG. 6B shows water with dissolved fertilizer flowing from the dissolving container 16 (not shown in FIG. 6B) through inlet pipe 38, through pipe 64 through water chamber 59 and through the square suction hole 56 into the water flowing through the suction device 34.

It is appreciated that the Venturi effect as well as the use of the Venturi effect as a suction device for introducing chemicals into water stream in a pipe is well known in the art.

The suction assembly, comprising the suction device 34 and the suction housing 35, including all the peripheral components as shown in FIGS. 2A to 6B. preferably enables the suction of fertilizer enriched water into the water flowing through nozzles tube 11 while the nozzles tube 11 is being rotated by the gear-driven engine.

The gear-driven engine preferably rotates the nozzles tube 11 and with it the suction device 34, which is firmly connected to the nozzles tube 11. As seen in FIGS. 6A and 6B, the suction device 34 preferably rotates within the suction housing 35. The suction housing 35 is preferably firmly connected, via the inlet pipe 38, to the dissolving container 16 and thus is not moving.

The suction device 34 uses the Venturi effect. Thus, the suction device 34 preferably contains a tube having a constriction and flaring, from the constriction, towards both ends of the tube, and a hole 56 at the constriction. Preferably, the input side of the tube is flaring at 20 degrees, and the output side of the tube is flaring at 13.4 degrees, as seen in FIG. 3C. The hole 56 is preferably connected to a pipe immersed in the liquid carrier containing the fertilizer. Preferably, the pipe is inlet pipe 38, which is firmly connected to the dissolving container 16 and thus is not moving. Preferably, hole 56 is connected to the inlet pipe 38 via a water chamber 59 created between the suction device 34 and the suction housing 35, as seen in FIG. 6A.

The input end of the tube preferably connects to a pressurized source of the irrigation liquid and the output end of the tube is connects to at least one irrigation output nozzle/Preferably, the output end of the tube is connected to the nozzles tube 11. The irrigation liquid flowing from the input end of the tube to the output end of the tube creates a lower pressure at the constriction, which creates suction through the hole 56 to draw carrier liquid containing the dissolved fertilizer from the dissolving container 16. Thus, the suction device 34 introduces the carrier liquid containing the dissolved fertilizer into the irrigation liquid flowing through the suction device 34 and into the nozzles tube 11, as seen in FIG. 6B.

Preferably, the hole 56 draws the carrier liquid containing the dissolved fertilizer from the water chamber created between the suction device 34 and the suction housing 35 and thus the suction device 34 can rotate within the suction housing 35, as seen in FIG. 6B, while preserving the flow of the carrier liquid into the irrigation liquid, as seen in FIG. 6B.

Reference is now made to FIG. 7, which is a simplified illustration of the flow of irrigation liquid through the fertigation device 10 according to a preferred embodiment of the present invention

As seen in FIG. 7, water 65 enters to the fertigation device 10 preferably through the hose connector 19 into the gear-driven engine box 26 (within the front cover 14). Preferably, most of the water flows thorough the gear-driven engine 13 putting the gear-driven engine in motion and thus effecting rotational motion of the nozzles tube 11. Preferably, part of the water flows from the gear-driven engine box 26 through the outlet pipe 27 into the dissolving container 16. The dissolving container 16 preferably contains fertilizer 66 and aqueous solution 67 containing dissolved fertilizer.

The water flowing through the suction device 34 creates suction at the Venturi constriction 68, thus sucking the aqueous solution 67 containing dissolved fertilizer through inlet pipe 38, through the water chamber 59 and through the hole 56 (not shown) into the water flowing into the nozzles tube 11.

The aqueous solution 67 containing dissolved fertilizer enters the nozzles tube 11, where it is further diluted, and then ejected through nozzles 12. As the nozzles tube 11 rotates by force of the gear-driven engine 13 water streams 21 containing twice-diluted fertilizer irrigate a predetermined area.

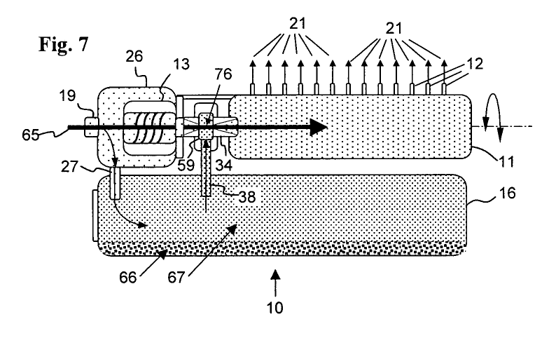

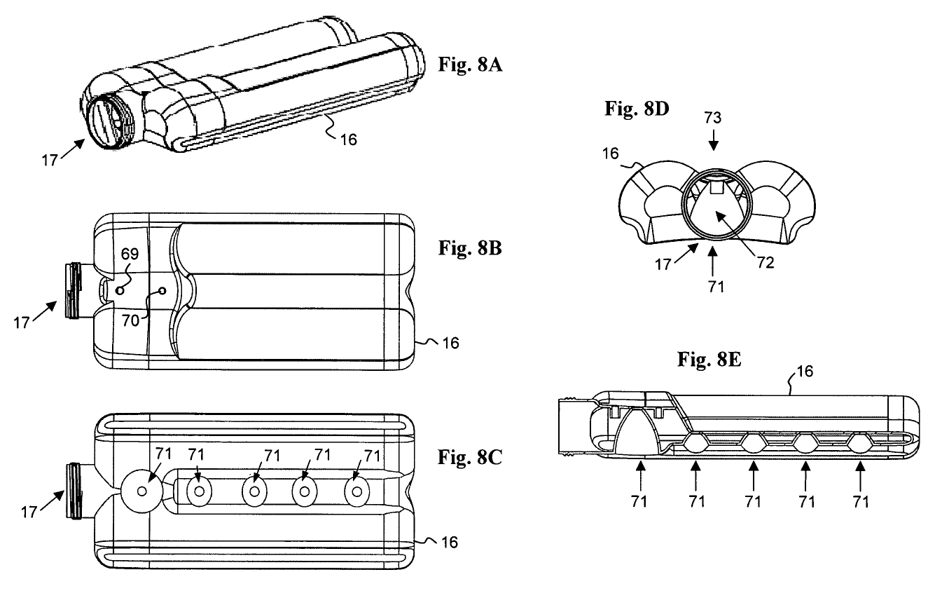

Reference is now made to FIGS. 8A, 8B, 8C, 8D and 8E, which are simplified schematics of, respectively, perspective view, top view, bottom view, latitude cut and longitude cut, of the dissolving container 16, according to a preferred embodiment of the present invention.

FIG. 8A shows the opening 17 where fertilizer can be inserted into the dissolving container 16. It is appreciated that the fertilizer is preferably measured, using a cup, preferably built into the dissolving container lid 18. The cup ratio is preferably in accordance with the formulation and in direct proportion to the size of the dissolving container 16 and to the required irrigation time.

FIG. 8B shows a tubular depression 69 in the dissolving container 16, where the water outlet pipe 27 is inserted into the dissolving container 16. FIG. 8B also shows a hole 70 into which inlet pipe 38 is inserted.

FIG. 8C shows depressions 71 in the dissolving container 16, top and bottom walls of the dissolving container 16 are mechanically connected for additional reinforcement, to reduce deformation of the dissolving container 16 caused by internal water pressure.

FIGS. 8D and 8E show reinforcement bindings 72 connecting the top and the bottom of the dissolving container 16 at the center. FIG. 8D also shows the longitudinal depression 73, in which the gear-driven engine box 26, suction device 34 and nozzles tube 11 are mounted.

The shape of the dissolving container 16 is designed to overcome two problems:
Possible deformation of the dissolving container 16 due to internal water pressure; and
Possible poor water circulation that may adversely affect the dissolving of the chemicals in the water inside the dissolving container 16.

These two problems are resolved by the combination of the longitudinal depression 74, the reinforcement bindings 72, and the vertical depressions 71.

For the gear-driven engine 13 to rotate the nozzles tube 11 the rotation axes of the gear-driven engine 13 and the nozzles tube 11 should be aligned. Water pressure inside the dissolving container 16 causes some deformation of the dissolving container 16. Since the gear-driven engine 13 and the nozzles tube 11 are connected tot the dissolving container 16, the deformation of the dissolving container 16 adversely affect the alignment of the rotation axes of the gear-driven engine 13 and the nozzles tube 11. Preferably, to eliminate this effect, the dissolving container 16 has the reinforcement bindings 72 shown in FIGS. 8D and 8E. Preferably, the reinforcement bindings 72 connect the top and the bottom of the dissolving container 16 along the rotation axis connecting the gear-driven engine 13 and the nozzles tube 11.

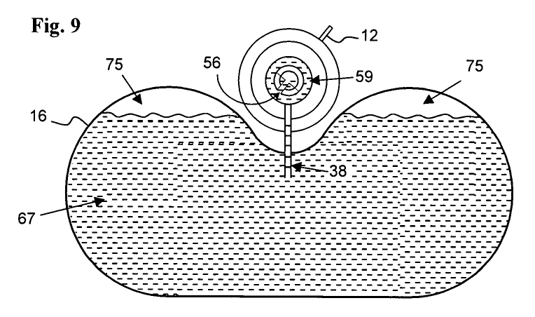

Reference is now made to FIG. 9, which is a simplified illustration of a latitude cut of the dissolving container 16 containing water, according to a preferred embodiment of the present invention.

As seen in FIG. 9, air 75 accumulates inside the dissolving container 16 near the top requires longer inlet pipe 38 if the inlet pipe 38 is inserted at the highest point of the dissolving container 16. However, the shape of the dissolving container 16, having the longitudinal depression 73, enables the use of a short and more effective inlet pipe 38.

It is therefore appreciated that the fertigation device 10 makes use of the following design elements:

An integral construction containing a dissolving container, such as dissolving container 16, for dissolving chemicals, such as fertilizers and pesticides, in flowing irrigation water, and a movable sprinkler device, such as the rotating nozzles tube 11, preferably maneuvered by a motor, such as gear-driven engine 13, which is preferably powered by the flowing irrigation water.

A dual stream fertigation system containing:
a first stream of irrigation water flowing through the gear-driven engine, and a sprinkler device, such as the rotating nozzles tube 11, in which the gear-driven engine moves the sprinkler device, and
a second stream of irrigation water flowing through a dissolving container, such as dissolving container 16, preferably bypassing the gear-driven engine, and merging into the first stream at the sprinkler device.

Thus, the fertigation system provides pressurized water stream through the dissolving container while the chemicals dissolved in the irrigation water do not flow thorough the gear-driven engine.

A dissolving container, preferably flat and elongated such as dissolving container 16, having a depression, preferably longitudinal, to shorten the distance, and/or to avoid air gap, between the water in the dissolving container and the merging point of the two streams.

A dissolving container, preferably flat and elongated such as dissolving container 16, having bindings between its walls, preferably internal bindings between the top and bottom walls, preferably along the container's longitude axis, thus reducing deformation of the container due to internal water pressure.

A suction device for merging the two streams, such as suction device 34, preferably by sucking water from the dissolving container into the sprinkler device or into the stream of water flowing from the gear-driven engine into the sprinkler device. In accordance with the embodiments described above, the dissolving container is the dissolving container 16, the sprinkler device is the rotating nozzles tube 11, the gear-driven engine is the gear-driven engine 13, and the suction device is the suction device 34.

A rotating suction device containing a rotating part and a fixed part. The rotating part, such as suction device 34, preferably connecting between the gear-driven engine and a movable sprinkler device such as the rotating nozzles tube 11. The fixed part, such as suction housing 35, preferably connecting a dissolving container such as dissolving container 16 and the rotating part. The rotating part preferably containing a Venturi device. The fixed part preferably containing a housing around the constriction of the Venturi device. Thus, the rotating suction device is continuously sucking water from the dissolving container into the stream of water flowing from the gear-driven engine into the sprinkler device while the sprinkler device is moving.

A dissolving container, preferably flat and elongated such as dissolving container 16, having flow diverting elements such as reinforcement bindings 72. The flow diverting elements are arranged to force water to flow throughout the container, thus improving the dissolving of the chemicals within the container.

It is expected that during the life of this patent many relevant fertigation devices and systems will be developed and the scope of the terms herein, particularly of the terms “gear-driven engine” and “nozzles tube”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An irrigation device, operative to introduce chemical into irrigation water flow, said irrigation device comprising:
a first container housing a gear-driven motor and having an input pipe connector operative to be connected to pressurized water supply;
a second container connected by a first pipe to said first container, said second container including at least one nozzle operative for spraying irrigation water, said second container being movable by said gear-driven motor; and
a third container operative to dissolve said chemical in water, said third container connected by a second pipe to said first container ahead of said gear-driven motor, and a third pipe connected to said second container;
whereby a first stream of water flows from said input pipe connector, through said first container, through said gear-driven motor, and through said first pipe into said second container while said second container is moving, and a second stream of water flowing from said first container, through said second pipe into said third container, and through said third pipe into said second container while said second container is moving.

2. An irrigation device according to claim 1 wherein said first pipe comprises:
a suction unit firmly connected to said second container, said suction unit comprising a tube connecting said first container and said second container, said tube comprising a hole; and
a housing unit forming a closed cavity around said hole and firmly connected by said third pipe to said third container;
wherein said first pipe is operative to merge a first stream of water flowing from said third container, through said hole, into a second stream of water flowing from said first container to said second container through said tube.

3. An irrigation device according to claim 2 wherein said suction unit comprising:
a tube having a constriction and flaring from said constriction towards both ends of said tube; and
a hole in a wall of said tube at said constriction.

4. An irrigation device according to claim 3 wherein said suction unit is a Venturi device.

5. An irrigation device according to claim 1 wherein said third container comprises an opening enabling a user to input dissolvable material into said third container.

6. An irrigation device according to claim 5 wherein said chemical comprises at least one of:
solid fertilizer
liquid fertilizer
solid pesticide; and
liquid pesticide.

7. An irrigation device according to claim 2 wherein said third container comprises a depression and wherein at least one of:
said second container;
said first pipe;
said suction device;
said housing unit; and
said third pipe
is mounted in said depression.

8. An irrigation device according to claim 1 wherein said third container comprises at least one reinforcement binding connecting its walls.

9. An irrigation device according to claim 1 wherein said third container comprises at least one water-flow diverting unit operative to circulate said water-flow through said third container.

10. A rotating suction unit comprising:
a tube comprising:
a constriction and flaring from said constriction towards both ends of said tube,
a tube hole through a wall of said tube at said constriction; and
a cylindrical outer surface at least partially around said hole and along said tube; and
a housing mounted around at least a part of said tube, said housing comprising:
an internal recess comprising edges at least partially round and attached to said cylindrical outer surface of said tube to form a sealed cavity around said tube hole;
a pipe external to said housing and connecting to said cavity through a hole in a wall of said housing;
wherein said tube and said housing are configured to enable at least one of:
rotation of said housing at least partially around said tube; and
rotation of said tube at least partially within said housing;
wherein said cavity is connected to said tube hole throughout said rotation, and wherein said edges are attached to said cylindrical outer surface of said tube throughout said rotation,
wherein a first end of said tube is operative to connect to a first source of at least one of liquid or gas to maintain a flow through said tube;
wherein said pipe is operative to connect to a second source of at least one of liquid or gas; and
wherein said flow thorough said tube creates suction at said tube hole to draw from said second source through said pipe and through said cavity and into said flow.

11. A method for moving an irrigation nozzle while introducing water chemical into irrigation water flow, said irrigation method comprising:
providing a gear-driven motor mounted in a first container, said first container and having an input pipe connector operative to be connected to pressurized water supply;
providing a second container connected by a first pipe to said first container, said second container including at least one nozzle operative for spraying irrigation water, said second container being movable by said gear-driven motor; and
providing a third container comprising an opening for inputting said chemical into said third container, said third container operative to dissolve said chemical in water, said third container connected by a second pipe to said first container ahead of said gear-driven motor, and a third pipe connected to said second container;
proving chemical into said third container; and
providing a first stream of water flowing from said input pipe connector, through said first container, through said gear-driven motor, and through said first pipe into said second container while said second container is moving, and a second stream of water flowing from said first container, through said second pipe into said third container, and through said third pipe into said second container while said second container is moving.

12. A method according to claim 11 wherein said first pipe comprises:
a suction unit firmly connected to said second container, said suction unit comprising a tube connecting said first container and said second container, said tube comprising a hole; and
a housing unit forming a sealed cavity around said hole and firmly connected by said third pipe to said third container;
wherein said first pipe is operative to merge a first stream of water flowing from said third container, through said hole, into a second stream of water flowing from said first container to said second container through said tube.

13. A method according to claim 12 wherein said suction unit comprising:
a tube having a constriction and flaring from said constriction towards both ends of said tube; and
a hole in a wall of said tube at said constriction.

14. A method according to claim 13 wherein said suction unit is a Venturi device.

15. A method according to claim 11 wherein said third container comprises an opening enabling a user to input dissolvable material into said third container.

16. A method according to claim 15 wherein said dissolvable material comprises at least one of:
solid fertilizer
liquid fertilizer
solid pesticide; and
liquid pesticide.

17. A method according to claim 12 additionally comprising:
providing said third container with a depression; and
mounting at least of:
said second container;
said first pipe;
said suction device;
said housing unit; and
said third pipe
in said depression.

18. A method according to claim 11 additionally comprising:
providing at least one reinforcement binding between walls of said third container.

19. A method according to claim 11 additionally comprising
providing at least one water-flow diverting unit within said third container, said water-flow diverting unit operative to circulate said water-flow through said third container.

20. A method for introducing a first liquid into a flow of a second liquid, said method comprising:
providing a flow of said first liquid through a tube, said tube comprising:
a constriction and flaring from said constriction towards both ends of said tube,
a tube hole through a wall of said tube at said constriction; and
a cylindrical outer surface at least partially around said hole and along said tube;
wherein said flow thorough said tube creates suction at said tube hole;
providing a housing mounted around at least a part of said tube, said housing comprising:
an internal recess comprising edges at least partially round and attached to said cylindrical outer surface of said tube to form a sealed cavity around said tube hole;
a pipe external to said housing and connecting to said cavity through a hole in a wall of said housing;
wherein said tube and said housing are configured to enable at least one of:
rotation of said housing at least partially around said tube; and
rotation of said tube at least partially within said housing;
wherein said cavity is connected to said tube hole throughout said rotation, and wherein said edges are attached to said cylindrical outer surface of said tube throughout said rotation, and
providing said second liquid at said pipe.

21. A method according to claim 20 wherein at least one of said first liquid and said second liquid is gaseous.
